(19) United States
(12) Patent Application Publication
(10) Pub. No.: US 2020/0197830 A1
(43) Pub. Date: Jun. 25, 2020

(54) SYSTEM AND METHOD FOR PERFORMING HEATING USING A HEATING VESSEL THAT IS PURGED

(71) Applicant: CHEMCHAMP NORTH AMERICA CORPORATION, OTTAWA (CA)

(72) Inventors: ELAD RIND, OTTAWA (CA); ISTVAN OKANYI, OTTAWA (CA)

(21) Appl. No.: 16/716,918

(22) Filed: Dec. 17, 2019

Related U.S. Application Data
(60) Provisional application No. 62/782,552, filed on Dec. 20, 2018.

(51) Int. Cl. B01D 3/34; B01D 3/02; B01D 3/42

(52) U.S. Cl. CPC B01D 3/346; B01D 3/42; B01D 3/02

(57) ABSTRACT

Disclosed is a distillation system having a distillation vessel configured to hold a mixture to be distilled, a heater configured to heat the distillation vessel to distill the mixture, and a heating vessel enclosing the heater. According to an embodiment, the heating vessel is configured to be purged, and the distillation system has a gas purge system configured to provide purging gas flow into the heating vessel. The purging gas flow prevents flammable gasses from entering the heating vessel and therefore there is no need for the heating vessel or the heater therein to be classified as explosion proof. In some implementations, the heater is an electrical heater in direct contact with the distillation vessel. The direct contact allows more efficient heating compared to an immersion heater, typically used in classified areas, in which there is no such direct contact and heat transfer fluid is required.

### RELATED APPLICATION

This application claims priority to U.S. Provisional Application Ser. No. 62/782,552 filed on Dec. 20, 2018, which is incorporated by reference in its entirety.

### FIELD OF THE DISCLOSURE

This disclosure relates to heating systems, and more particularly to heating systems used with distillation units.

### BACKGROUND

Distillation is a process of separating components or substances from a liquid mixture by using selective boiling and condensation. The boiling involves heating the liquid mixture using a heater. Depending on the liquid mixture, an area where the process is taking place may involve some risk due to flammable vapours present in the environment. Unfortunately, if a flammable vapour is ignited, there may be an explosion.

With safety in mind, there are relevant standards that should be obeyed. For example, UL 823, entitled “Electric Heaters for use in Hazardous (Classified) Locations” is a standard dealing with heaters for hazardous locations. As another example, UL 2208, entitled “Standard for Solvent Distillation Units”, is a standard dealing with distillation units for hazardous locations, among others.

One approach for ensuring that a distillation system adheres to the relevant standards is to design the distillation system such that any electrical component that could possibly produce a spark is placed inside an explosion proof container. FIG. 1 is a schematic of an explosion proof container 100 having a body portion 102 and a cover portion 101 that can be bolted to the body portion 102. Even if a flammable gas seeps into the explosion proof container 100 and is ignited, any explosion should be restricted to within the explosion proof container 100.

Unfortunately, explosion proof containers such that the one depicted in FIG. 1 are very expensive, very heavy, and not always practical, especially when heaters are considered.

### SUMMARY OF THE DISCLOSURE

Disclosed is a distillation system having a distillation vessel configured to hold a mixture to be distilled, a heater configured to heat the distillation vessel to distill the mixture, and a heating vessel enclosing the heater. According to an embodiment, the heating vessel is configured to be purged, and the distillation system has a gas purge system configured to provide purging gas flow into the heating vessel. The purging gas flow prevents flammable gasses from entering the heating vessel (due to positive gas pressure) and therefore there is no need for the heating vessel or the heater therein to be classified as explosion proof. In some implementations, the heater is an electrical heater in direct contact with the distillation vessel. The direct contact allows more efficient heating compared to an immersion heater, typically used in classified areas, in which there is no such direct contact. In particular, the direct contact circumvents any need to spend energy on heating a transfer fluid as is done in immersion heaters. A corresponding method of distilling a mixture is also disclosed.

Also disclosed is a heating system having a heater configured to heat an object, and a heating vessel enclosing the heater. According to an embodiment, the heating vessel is configured to be purged, and the heating system has a gas purge system configured to provide purging gas flow into the heating vessel. The object can for example be a conduit configured to transfer heat to a fluid that is flowing through the conduit. The object does not need to be a distillation vessel and may or may not form part of the heating system. Thus, some embodiments of the disclosure are applicable to applications other than distillation. In some implementations, the heater is an electrical heater in direct contact with the object. The direct contact allows more efficient heating compared to an immersion heater, typically used in classified areas, in which there is no such direct contact. In particular, the direct contact circumvents any need to spend energy on heating a transfer fluid as is done in immersion heaters. A corresponding method of heating an object is also disclosed.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a schematic of an explosion proof container;

FIG. 2 is a schematic of a distillation system featuring a heating vessel enclosing an immersion heater;

FIG. 3 is a schematic of the immersion heater shown in FIG. 2;

FIG. 4 is a schematic of a distillation system featuring a heating vessel enclosing a band heater;

FIG. 5A is a schematic of the band heater shown in FIG. 4;

FIG. 5B is a schematic of a mould heater that can be implemented instead of the band heater shown in FIG. 4;

FIG. 6 is a flowchart of a method for distilling a mixture;

FIG. 7 is a schematic of a heating system featuring a heating vessel enclosing a band heater; and

FIG. 8 is a flowchart of a method for heating an object.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

### INTRODUCTION

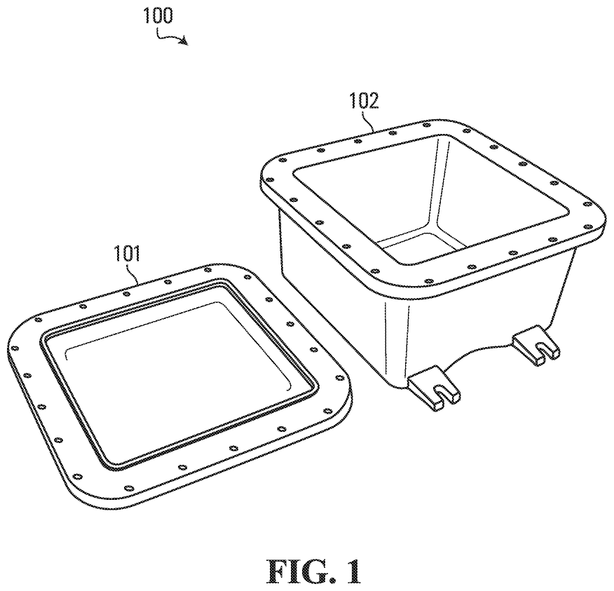

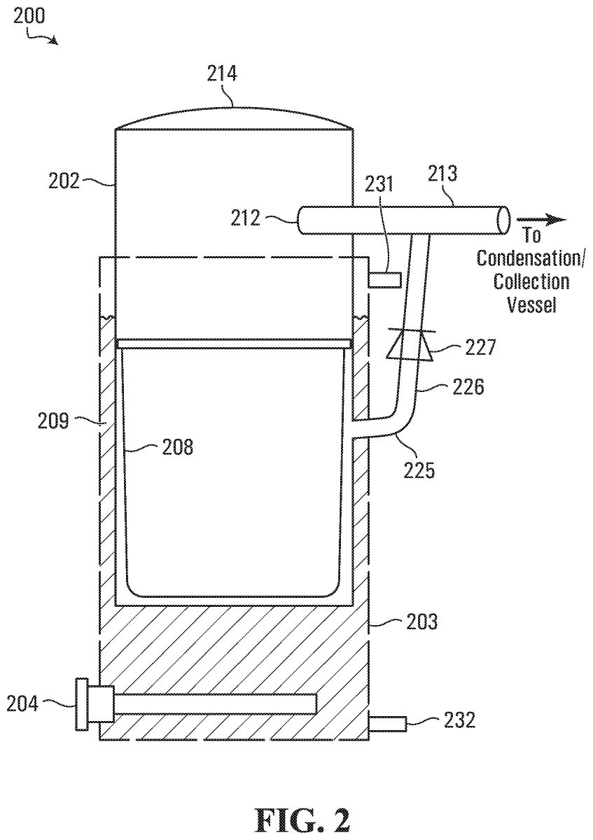

With regards to electrical heaters, to comply with UL 823, an electrical heater should be immersed in a non-flammable fluid in order to avoid any flammable vapour from reaching the electrical heater. Moreover, all electrical connections for the electrical heater should be encapsulated inside an explosion proof enclosure such as the explosion proof container 100 shown in FIG. 1. One approach is to use an immersion heater submerged in a heat transfer fluid as described below with reference to FIG. 2. The heat transfer fluid can for example be oil or water.

Referring now to FIG. 2, shown is a schematic of a distillation system 200 featuring a heating vessel 203 enclosing an immersion heater 204 submerged in a heat transfer fluid 209. During operation, the immersion heater 204 heats up the heat transfer fluid 209 in the heating vessel 203, which in turn heats up a distillation vessel 202 in which contaminated solvent or solvent mixture to be recovered is located. Heat is applied to the distillation vessel 202 to vaporize the solvent.

In some implementations, the distillation vessel 202 prevents escape of any vapour generated in the distillation vessel 202 other than through a conduit 213, which leads to a condensation/collection vessel (not shown). In some implementations, the conduit 213 connects to an outlet 212 at an upper end of the distillation vessel 202 because hot vapour will tend to rise. In some implementations, the conduit 213 also connects to a secondary outlet 225 at a lower portion of the distillation vessel 202 through a secondary conduit 226 having a one-way valve 227 to prevent reverse flow of vapour from the secondary conduit 226. In some implementations, the conduit 213 is large enough to allow free passage of vapour from the distillation vessel 202 without resulting in a pressure build up in the distillation vessel 202. In some implementations, the distillation vessel 202 has a lid 214 incorporating an anti-pressure device such that, if there is significant pressure buildup (e.g. the conduit 213 and/or the inlets 212 and 225 become blocked), the lid 214 is released.

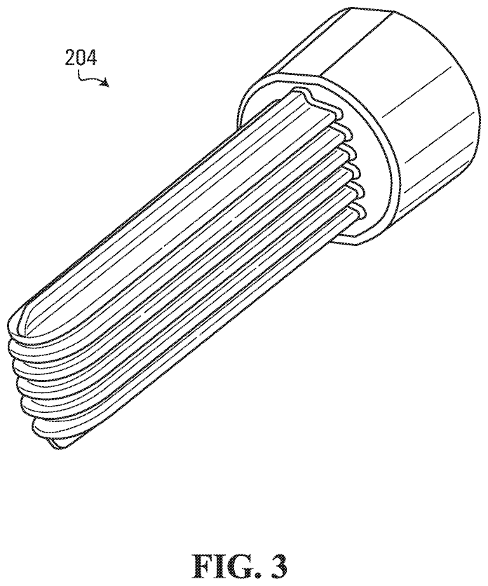

The immersion heater 204 includes one or more heating elements 204 immersed in the heat transfer fluid 209 and, in operation, each heating element 204 heats the heat transfer fluid 209 which in turn heats the distillation vessel 202 at least until the solvent within the distillation vessel 202 reaches its boiling point and vapour is generated. FIG. 3 is a schematic of the heating element 204. In some implementations, once the boiling point of the solvent is reached, power supplied to the heating elements is controlled to regulate a rate of vaporization of the solvent until the solvent is substantially all evaporated.

Continued heating of the distillation vessel 202 drives off any residual solvents and bakes any contaminants in the distillation vessel 202 so that resulting solids may be disposed of more conveniently at a lower cost and with reduced environmental problems as compared to unbaked contaminants. In some implementations, the distillation vessel 202 is lined with a bag 208 such that, following baking, the bag 208 containing the baked contaminants can be disposed of. The bag 208 is stable within a temperature range of the distillation vessel 202 and is inert with respect to the solvents to be distilled. The bag 208 is made of any suitable material that is heat stable, does not react with the solvents to be distilled, and is non-permeable.

Distillation of the solvent may involve some risk that a flammable vapour is produced. If the flammable vapour is ignited, there may be an explosion. Fortunately, the heat transfer fluid 209 in the heating vessel 203 can prevent flammable vapours from entering the heating vessel 203 and therefore there may be no contact between the heating element 204 and the flammable vapours. Thus, only electrical connections of the heating element 204 should be encapsulated in an explosion proof enclosure (not shown) to comply with UL 823. This can reduce size requirements of the explosion proof enclosure, as there is no need for the heating vessel 203 or the heater 204 therein to be classified as explosion proof.

Unfortunately, the heat transfer fluid 209 in the heating vessel 203 introduces a large heat capacity, which can make heating the distillation vessel 202 relatively inefficient. Also, after the distillation is completed, it may be desirable to cool down the distillation system 200 for safety reasons before the waste is being removed and disposed of. This, however, may be difficult due to the large heat capacity of the heat transfer fluid 209. The heat transfer fluid 209 can be drained out of an outlet 232 for cooling via a heat exchanger (not shown) and then re-introduced via an inlet 231. However, this process is energy and time consuming, and cumbersome. For example, in large systems, it could take several hours to cool down the heat transfer fluid 209.

An alternative approach may be to use externally supplied steam, for example, when heating a distillation vessel. However, this again relies on a heat transfer fluid (i.e. steam instead of oil or water as previously described). Relying on externally supplied steam has disadvantages much like relying on oil or water: (A) running hot fluid over a long distance exposes the distillation system to additional losses, and (B) steam boilers are large and usually operate using natural gas, which is may be inefficient when compared to using electrical heaters. In general, relying on a heat transfer fluid is not preferred.

### System and Method for Distilling a Mixture

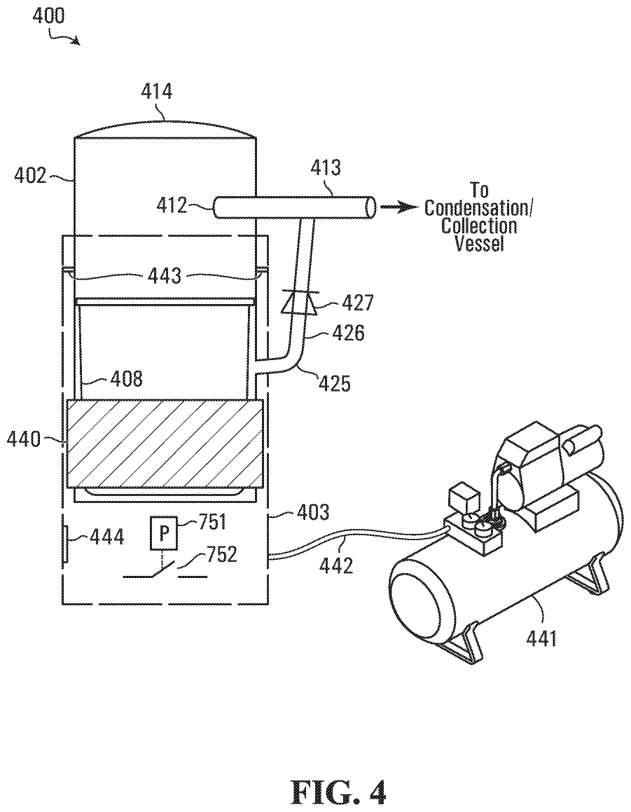

Referring now to FIG. 4, shown is a schematic of a distillation system 400 featuring a heating vessel 403 enclosing a band heater 440. While the distillation system 400 implements the band heater 440 as shown, as will be described in greater detail below, any suitable electrical heater can be implemented, whether for classified environments or for general use. During operation, the band heater 440 heats up the distillation vessel 202 in which contaminated solvent or solvent mixture to be recovered is collected. Heat is applied to the distillation vessel 202 to vaporize the solvent.

According to an embodiment, the heating vessel 403 is configured to be purged, and the distillation system 400 has a gas purge system 441 configured to provide purging gas flow into the heating vessel 403 through a conduit 442. The purging gas flow prevents flammable gasses from entering the heating vessel 403 (due to positive gas pressure) and therefore there is no need for the heating vessel 403 or the heater 440 therein to be classified as explosion proof. In some implementations, the heating vessel 403 has a purging system vent 444 and a sealed shell to limit outgoing gas flow out of the heating vessel 403 through only the purging system vent 444. To this end, the heating vessel 403 has a seal 443 with the distillation vessel 202.

Furthermore, given that the purging gas flow is used to prevent flammable gasses from entering the heating vessel 403, there is flexibility in terms of what sort of heater can be implemented. Notably, an immersion heater such the immersion heater 204 shown in FIG. 2 is no longer required, and so the problems with using heat transfer fluid may be avoided. Instead, in some implementations, the heating vessel 403 implements the band heater 440 such that there is direct contact with the distillation vessel 402. The direct contact can allow for more efficient heating compared to an immersion heater in which there is no such direct contact.

Applicant notes that NFPA 496, entitled “Standard for Purged and Pressurized Enclosures for Electrical Equipment”, is a standard that provides information on the methods for purging and pressurizing electrical equipment enclosures to prevent ignition of a flammable atmosphere, whether introduced into the enclosure by a surrounding external atmosphere or by an internal source. According to the standard, because the purging gas flow is used to prevent flammable gasses from entering the heating vessel 403, the distillation system 400 can use a direct heat source such as the band heater 440 which does not require an intermittent heat transfer liquid.

There are several potential advantages with the distillation system 400 of FIG. 4 over the distillation system 200 of FIG. 2. Notably, there is no need for heat transfer fluid and its supporting mechanical systems. Thus, the difficulties with heating and/or cooling the heat transfer fluid can be avoided. Also, there can be reduced operating temperatures because heat is being transferred directly to the processed media. In addition, the distillation system 400 of FIG. 4 is a simpler system that may be less expensive.

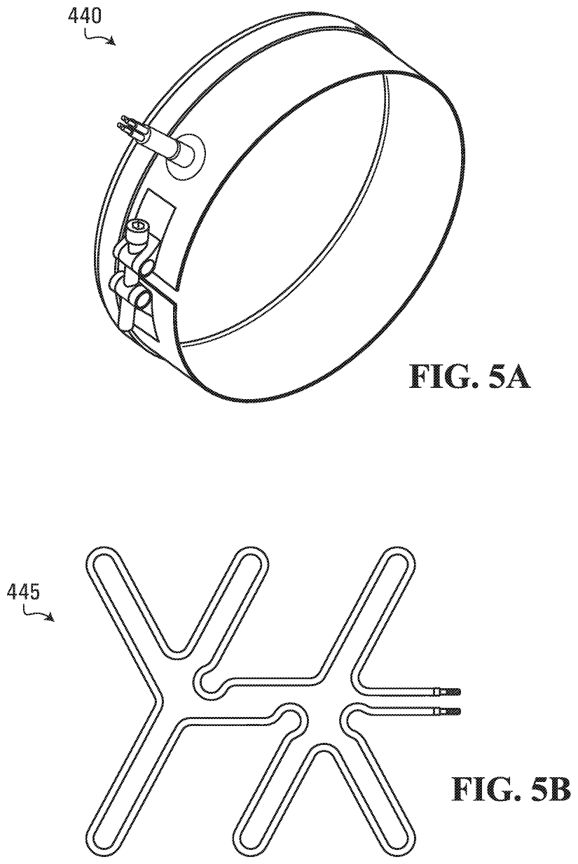

The band heater 440 includes one or more heating elements 440 that wrap around the distillation vessel 402 and, in operation, each heating element 440 heats the distillation vessel 402 at least until the solvent within the distillation vessel 402 reaches its boiling point and vapour is generated. FIG. 5A is a schematic of the heating element 440. In some implementations, once the boiling point of the solvent is reached, power supplied to the heating elements is controlled to regulate a rate of vaporization of the solvent until the solvent is substantially all evaporated.

Although the band heater 440 is depicted in the illustrated example, it is to be understood that other heaters are possible and are within the scope of this disclosure. Any suitable electrical heater can be implemented, whether for classified environments or for general use. For example, in other implementations, the distillation system 400 implements a mould heater at a bottom portion of the distillation chamber 402. FIG. 5B is a schematic of a mould heater 445 that can be implemented instead of the band heater 440 shown in FIG. 4. In some implementations, the distillation system 400 implements any suitable electrical heater having a heating element in direct contact with an outside surface of the distillation vessel, whether heater is a band heater, a mould heater or some other heater. In such implementations, the heater is in direct contact with the distillation vessel 402. In other implementations, there is some amount of spacing between the heater and the distillation vessel 402. However, spacing between the heater and the distillation vessel 402 may reduce efficiency. Thus, in some implementations, spacing between the heater and the distillation vessel 402 is mitigated or eliminated.

In some implementations, the distillation vessel 402 prevents escape of any vapour generated in the distillation vessel 402 other than through a conduit 413, which leads to a condensation/collection vessel (not shown). In some implementations, the conduit 413 connects to an outlet 412 at an upper end of the distillation vessel 402 because hot vapour will tend to rise. In some implementations, the conduit 413 also connects to a secondary outlet 425 at a lower portion of the distillation vessel 402 through a secondary conduit 426 having a one-way valve 427 to prevent reverse flow of vapour from the secondary conduit 426. In some implementations, the conduit 413 is large enough to allow free passage of vapour from the distillation vessel 402 without resulting in a pressure build up in the distillation vessel 402. In some implementations, the distillation vessel 402 has a lid 414 incorporating an anti-pressure device such that, if there is significant pressure buildup (e.g. the conduit 213 and/or the inlets 212 and 225 become blocked), the lid 214 is released.

Continued heating of the distillation vessel 402 drives off any residual solvents and bakes any contaminants in the distillation vessel 402 so that resulting solids may be disposed of more conveniently at a lower cost and with reduced environmental problems as compared to unbaked contaminants. In some implementations, the distillation vessel 402 is lined with a bag 408 such that, following baking, the bag 408 containing the baked contaminants can be disposed of. The bag 408 is stable within a temperature range of the distillation vessel 402 and is inert with respect to the solvents to be distilled. The bag 408 is made of any suitable material that is heat stable, does not react with the solvents to be distilled, and is non-permeable.

In the illustrated example, the gas purge system 441 includes an air compressor configured to provide the gas flow (i.e. airflow) into the heating vessel 403. The air compressor can be located outside of the classified area. However, other gas purge systems are possible. More generally, any gas purge system that can provide clean gas (e.g. air) to the heating vessel 403 may be implemented. The clean gas can originate from a remote location having clean air (e.g. outside), or from a local compressed gas vessel (e.g. air or nitrogen).

In some implementations, the distillation system 400 has a sensor 751 configured to measure an internal gas pressure inside of the heating vessel 403, and a switch 752 configured to turn off to the band heater 440 when the internal gas pressure deviates from an operating range. The operating range can be chosen so that no flammable gasses can enter the heating vessel 403. In some implementations, the operating range is between zero and ten PSI (pound-force per square inch) greater than an external gas pressure outside of the heating vessel. In specific implementations, the operating range is 0.1 PSI to 0.3 PSI greater than the external gas pressure outside of the heating vessel. Other implementations are possible.

In some implementations, if at any point of time there is insufficient pressure inside the heating vessel 403, power is immediately and automatically disconnected from the band heater 440 and other components as well. In some implementations, the switch 752 is used to power other electrical systems on the distillation system 400. As such, triggering the switch 752 to open can disconnect power to any electrical systems powered by it.

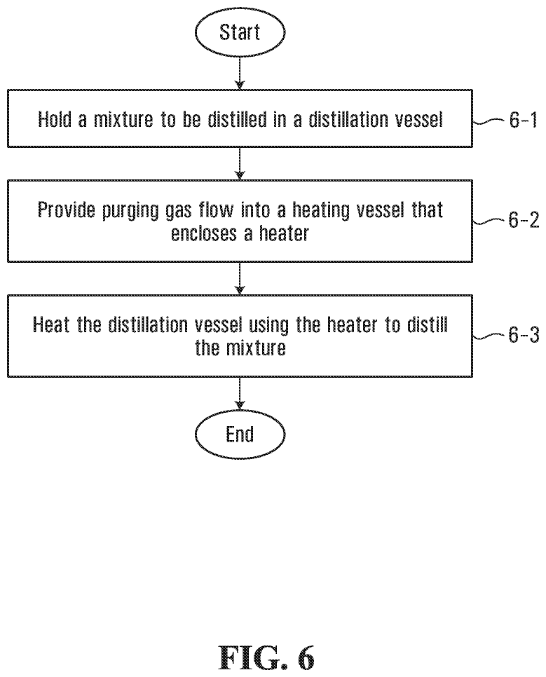

Referring now to FIG. 6, shown is a flowchart of a method for distilling a mixture. This method may be executed by a distillation system, for example the distillation system 400 shown in FIG. 4, or any other appropriately configured distillation system. Although the flowchart depicts steps being executed in sequence, it is to be understood that some steps may be executed concurrently or in an alternative order to that shown.

At step 6-1, the distillation system holds a mixture to be distilled in a distillation vessel. At step 6-2, the distillation system provides purging gas flow into a heating vessel that encloses a heater. As explained above, the purging gas flow prevents flammable gasses from entering the heating vessel and therefore there is no need for the heating vessel or the heater therein to be classified as explosion proof. Also, given that the purging gas flow is used to prevent flammable gasses from entering the heating vessel, there is flexibility in terms of what sort of heater can be implemented.

Finally, at step 6-3, the distillation system heats the distillation vessel using the heater to distill the mixture. In some implementations, the distillation system heats the distillation vessel at step 6-3 only after the purging gas flow at step 6-2 is performed long enough to ensure safety. In some implementations, power is provided to the distillation system only after the purging gas flow is provided for at least a predefined time period, or when a gas purge system acknowledges safety. The heating at step 6-3 can be performed after power is supplied. In some implementations, a user initiates the heating, for example by pressing a start button. In other implementations, the heating is initiated automatically.

In some implementations, the distillation system maintains direct contact between the heater and the distillation vessel. As explained above, the direct contact allows more efficient heating compared to an immersion heater in which there is no such direct contact.

In some implementations, the distillation system measures an internal gas pressure inside of the heating vessel, and turns off the heater when the internal gas pressure deviates from an operating range. Example details have been provided above for FIG. 4 and therefore are not repeated here.

In some implementations, if at any point of time there is insufficient pressure inside the heating vessel, power is immediately and automatically disconnected from the heater and other components as well. Example details have been provided above for FIG. 4 and therefore are not repeated here.

### System & Method for Heating an Object

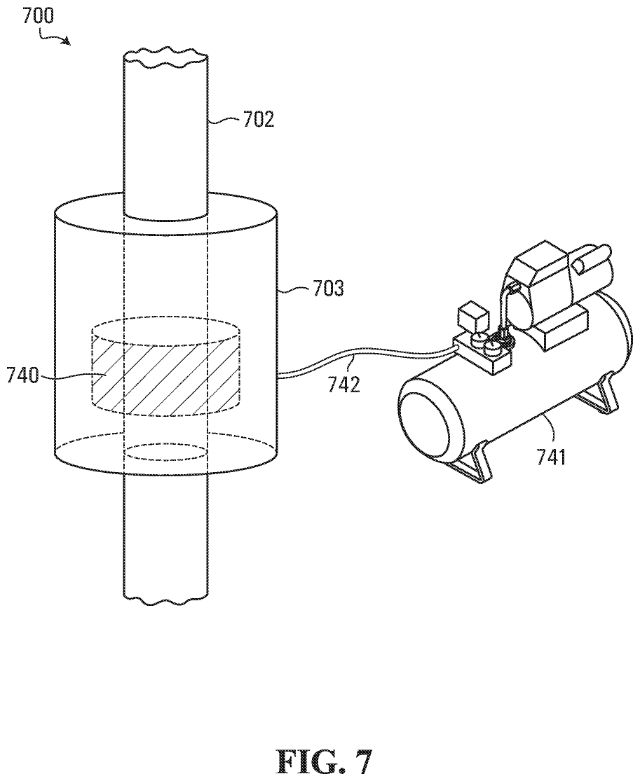

Referring now to FIG. 7, shown is a schematic of a heating system 700 featuring a heating vessel 703 enclosing a band heater 740. During operation, the band heater 740 heats up an object 702. The object 702 can for example be a conduit configured to transfer heat to a fluid that is flowing through the conduit. The object 702 does not need to be a distillation vessel and may or may not form part of the heating system 700. Thus, some embodiments of the disclosure are applicable to applications other than distillation. An example application is a steam boiler. Another example application is a heater sitting inside an electrical cabinet in the arctic.

According to an embodiment, the heating vessel 703 is configured to be purged, and the distillation system 700 has a gas purge system 741 configured to provide purging gas flow into the heating vessel 703 through a conduit 742. The purging gas flow prevents flammable gasses from entering the heating vessel 703 and therefore there is no need for the heating vessel 703 or the heater therein to be classified as explosion proof. Also, given that the purging gas flow is used to prevent flammable gasses from entering the heating vessel 703, there is flexibility in terms of what sort of heater can be implemented.

While the heating system 700 implements the band heater 740 as shown, much like the distillation system 400 described above with reference to FIG. 4, any suitable electrical heater can be implemented, whether for classified environments or for general use. In some implementations, the electrical heater is in direct contact with the distillation vessel. As explained above, the direct contact allows more efficient heating compared to an immersion heater, typically used in classified areas, in which there is no such direct contact.

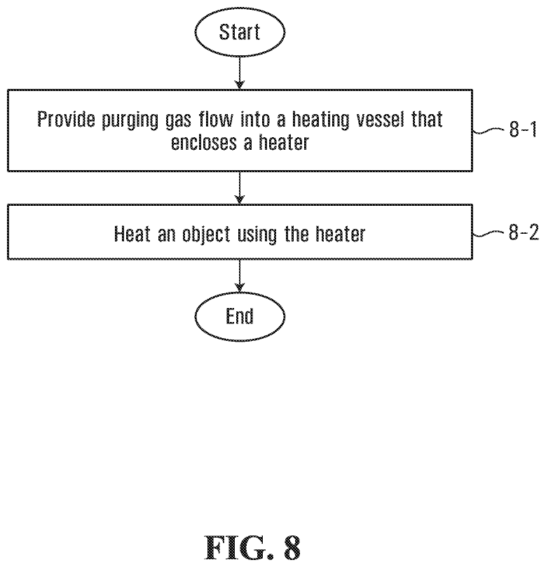

Referring now to FIG. 8, shown is a flowchart of a method for heating an object. This method may be executed by a heating system, for example the heating system 700 shown in FIG. 7, or any other appropriately configured heating system. Although the flowchart depicts steps being executed in sequence, it is to be understood that some steps may be executed concurrently or in an alternative order to that shown.

At step 8-1, the heating system provides purging gas flow into a heating vessel that encloses a heater. As explained above, the purging gas flow prevents flammable gasses from entering the heating vessel and therefore there is no need for the heating vessel or the heater therein to be classified as explosion proof. Also, since the purging gas flow is used to prevent flammable gasses from entering the heating vessel, there is flexibility in terms of what sort of heater can be implemented.

Finally, at step 8-2, the heating system heats the object using the heater. In some implementations, the heating system heats the object at step 8-2 only after the purging gas flow at step 8-1 is performed long enough to ensure safety. In some implementations, power is provided to the heating system only after the purging gas flow is provided for at least a predefined time period, or when a gas purge system acknowledges safety. The heating at step 8-2 can be performed after power is supplied. In some implementations, a user initiates the heating, for example by pressing a start button. In other implementations, the heating is initiated automatically.

In some implementations, the heating system maintains direct contact between the heater and the object. As explained above, the direct contact allows more efficient heating compared to an immersion heater in which there is no such direct contact.

In some implementations, the heating system measures an internal gas pressure inside of the heating vessel, and turns off the heater when the internal gas pressure deviates from an operating range. Example details have been provided above for FIG. 4 and therefore are not repeated here.

In some implementations, if at any point of time there is insufficient pressure inside the heating vessel, power is immediately and automatically disconnected from the heater and other components as well. Example details have been provided above for FIG. 4 and therefore are not repeated here.

Numerous modifications and variations of the present disclosure are possible in light of the above teachings. It is therefore to be understood that within the scope of the appended claims, the disclosure may be practised otherwise than as specifically described herein.

We claim:

1. A distillation system comprising:
a distillation vessel configured to hold a mixture to be distilled;
a heater configured to heat the distillation vessel to distill the mixture;
a heating vessel enclosing the heater and configured to be purged; and
a gas purge system configured to provide purging gas flow into the heating vessel.

2. The distillation system of claim 1, wherein the heater is in direct contact with the distillation vessel.

3. The distillation system of claim 1, wherein the heater is an electrical heater having a heating element in direct contact with an outside surface of the distillation vessel.

4. The distillation system of claim 1, wherein the heater is a band heater.

5. The distillation system of claim 1, wherein the heater is a mould heater.

6. The distillation system of claim 1, wherein the heating vessel comprises a purging system vent and a sealed shell to limit outgoing gas flow out of the heating vessel through only the purging system vent.

7. The distillation system of claim 1, wherein the gas purge system comprises an air compressor configured to provide the purging gas flow into the heating vessel.

8. The distillation system of claim 1, further comprising:
a sensor configured to measure an internal gas pressure inside of the heating vessel; and
a switch configured to turn off the heater when the internal gas pressure deviates from an operating range.

9. The distillation system of claim 7, wherein the operating range is between zero and ten PSI (pound-force per square inch) greater than an external gas pressure outside of the heating vessel.

10. The distillation system of claim 9, wherein the operating range is 0.1 PSI to 0.3 PSI greater than the external gas pressure outside of the heating vessel.

11. A method of distilling a mixture, comprising:
holding a mixture to be distilled in a distillation vessel;
providing purging gas flow into a heating vessel that encloses a heater; and
heating the distillation vessel using the heater to distill the mixture.

12. The method of claim 11, further comprising:
maintaining direct contact between the heater and the distillation vessel.

13. The method of any claim 11, further comprising:
measuring an internal gas pressure inside of the heating vessel; and
turning off the heater when the internal gas pressure deviates from an operating range.

14. The method of claim 13, wherein the operating range is between zero and ten PSI (pound-force per square inch) greater than an external gas pressure outside of the heating vessel.

15. The method of claim 14, wherein the operating range is 0.1 PSI to 0.3 PSI greater than the external gas pressure outside of the heating vessel.

16. A heating system comprising:
a heater configured to heat an object;
a heating vessel enclosing the heater and configured to be purged; and
a gas purge system configured to provide purging gas flow into the heating vessel.

17. The heating system of claim 16, wherein the heating system comprises the object.

18. The heating system of claim 16, wherein the object comprises a conduit configured to enable flow of a fluid, and the conduit transfers heat to the fluid while the fluid flows through the conduit.

19. The heating system of claim 16, wherein the heater is in direct contact with the object.

20. A method of heating an object, comprising:
providing purging gas flow into a heating vessel that encloses a heater; and
heating the object using the heater.
